(19) United States
(12) Patent Application Publication
(10) Pub. No.: US 2008/0145305 A1
(43) Pub. Date: Jun. 19, 2008

(54) Process for the removal of metals using an open framework chalcogenide

(75) Inventors: Mercouri G. Kanatzidis, Wilmette, IL (US); Manolis J. Manos, Evanston, IL (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 11/977,660

(22) Filed: Oct. 25, 2007

Related U.S. Application Data
(60) Provisional application No. 60/854,513, filed on Oct. 26, 2006.

(51) Int. Cl. C02F 1/42; C01B 17/00

(52) U.S. Cl. 423/511

(57) ABSTRACT

An alkali metal chalcogenide, particularly K₆Sn₅Zn₄S₁₇, is described as useful in a process for the removal of mercury ions or other metal ions, particularly the selective removal of mercuric or other soft metal ions from water. The resulting metal chalcogenide is new. The invention can be used for the removal of mercury ions from potable water and other metal ion contaminated solutions, or from gaseous fluids.

### CROSS-REFERENCE TO RELATED APPLICATIONS

This application claims benefit to U.S. Provisional Application Ser. No. 60/854,513, filed Oct. 26, 2006, which is incorporated herein by reference in its entirety.

### STATEMENT REGARDING GOVERNMENT RIGHTS

This invention was made under United States National Science Foundation Nos. DMR-0443785 and CHE-0211029. The Government has certain rights to this invention.

### BACKGROUND OF THE INVENTION

(1) Field of the Invention

The present invention relates to the separation of heavy or soft metals, particularly mercury and, from fluids which can be gases or liquids. In particular, the present invention relates to a highly selective and rapid removal of mercuric ions Hg²⁺ from solvents, such as water, by in particular using the chalcogenide K₆Sn₅Zn₄S₁₇.

(2) Description of the Related Art

Active charcoal has been tested for removal of Hg and Pb from waste water. Although it is a cheap material, it has low selectivity and removal capacity for Hg (1 mg Hg/g of the material). Mesoporous silicates functionalized with thiol (—SH) groups that have high affinity for Hg have shown a high capacity to adsorb Hg. However, the number of thiol groups grafted to the silicate framework is very limited. This is because of the limited acid (Silinol) sites for attachment of organofunctional groups containing the thiol to the silica framework and steric hindrance effects between the anchored organic groups. These problems limit the possibilities for providing silicate materials with higher capacity and selectivity than those already known.

U.S. Pat. Nos. 5,614,128 and 5,618,471 to the present inventor describe the chalcogenides used in the present invention, which are incorporated herein by reference in their entireties. There is no suggestion of the present invention. Manos et al., Angew. Chem. Int. Ed. 2005, 44, 3552-3555, including the present inventor as an author, also describes the chalcogenides used in the present invention. This reference is incorporated herein by reference in its entirety. This reference generally describes the exchange of Rb and Cs ions with potassium in the chalogenide. There is no disclosure of heavy metals.

### OBJECTS

It is, therefore, an object of the present invention to provide a novel process for the selective separation of heavy metals, particularly mercury, from fluids, more particularly mercuric ions (Hg²⁺) in an aqueous solution. It is further an object to provide a process which is rapid and economical. These and other objects will become increasingly apparent by reference to the following description and the drawings.

### SUMMARY OF THE INVENTION

The present invention relates to a process for the separation of heavy or soft metal ions in ionic form from a fluid, which comprises: (a) providing a chalogenide, having the formula A₆Sn₅Zn₄S₁₇ where A is an alkali metal ion and an open framework comprised of the A ion group in the pores of the framework, in a fluid comprising the metal ions, so that the metal ions displace at least some of the A ions in the framework openings to provide a metal chalogenide; and (b) separating the metal chalogenide from the fluid.

Further, the present invention relates to a process for the separation of heavy metal ions in ionic form from a fluid which comprises: (a) providing a chalogenide, having the formula A₆Sn₅Zn₄S₁₇ where A is an alkali metal ion and an open framework comprised of the A ion group in the pores of the framework, in a fluid comprising the heavy metal ions, so that the heavy metal ions displace at least some of the A ions in the framework openings to provide a heavy metal chalogenide; and (b) separating the heavy metal chalogenide from the fluid.

Still further, the present invention relates to a process for the separation of mercury ions in ionic form from a liquid which comprises: (a) providing a chalogenide, having the formula K₆Sn₅Zn₄S₁₇ and having an open framework comprised of potassium ions in openings in the framework, in the liquid comprising the mercury in ionic form so that the mercury displaces at least some of the potassium ions in the framework openings to provide a mercuric chalcogenide; and (b) separating the mercuric chalcogenide from the liquid.

Still further, the present invention relates to a process for the separation of mercury in an ionic form from an aqueous solution which comprises: (a) introducing a chalcogenide having the formula K₆Sn₅Zn₄S₁₇ and an open framework comprised of potassium ions in openings in an aqueous solution comprising the mercury in the ionic form so that the mercury displaces at least some of the potassium ions in the framework openings to provide a mercuric chalcogenide; and (b) separating the mercuric chalcogenide from the aqueous solution.

Preferably, wherein sodium or calcium ions are produced in an aqueous solution with the mercury ions. More preferably, wherein the metal is selected from the group consisting of: Ag⁺, Cd²⁺, CH₃Hg⁺, Pb²⁺, Tl⁺, Au⁺ and Pd²⁺, and mixtures thereof. Preferably, wherein a heavy metal chalcogenide of the formula MₓK_{y}Sn₅Zn₄S₁₇ where M is the heavy metal, x is between 0.5 and 2.5, y is 5-2×. Still further, the present invention relates to a mercury chalcogenide having the formula HgₓK₅₋₂ₓSn₅Zn₄S₁₇ with an open framework comprised of mercury and potassium ions in openings of the framework and where x is between 0.5 and 2.5, y is 5−2x. Preferably, wherein the heavy metal is selected from the group consisting of Au, S, Ag, Pb, Cu and mixtures thereof. Thus, chalcogenide can have manganese or magnesium in place of zinc. It is noted that sometimes the metals are more broadly referred to as “soft” metals in that they are malleable or liquid in the case of mercury, gold, silver, lead, cadium and thallium. These include Ag⁺, Cd²⁺, CH₃Hg⁺, Pb²⁺, Tl⁺, Au⁺, Pd²⁺, and Cu²⁺. Pb, Au, Cu and Ag are sometimes referred to as heavy metals.

The present invention also relates to a process for the separation of soft or heavy metal ions in ionic form from a fluid which comprises: providing a chalcogenide, having the formula A₆Sn₅Z₄S₁₇ where A is an alkali metal ion and an open framework comprised of the A ion group in the pores of the framework, and where Z is selected from the group consisting of Zn, Mn, and Mg or mixtures thereof, in a fluid comprising the metal ions, so that the metal ions displace at least some of the A ions in the framework openings to provide a metal chalcogenide to separate the metal ions from the fluid.

The substance and advantages of the present invention will become increasingly apparent by reference to the following drawings and the description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A represents the [Zn₄Sn₄S₁₇]¹⁰ cluster which is the building block of K₆Sn₅Zn₄S₁₇. FIG. 1B shows a [010] projection showing the absence of a center of symmetry in the structure of K₆Sn₅Zn₄S₁₇. Yellow, red and blue balls represent S, Sn and Zn atoms, respectively. K ions were removed for clarity. FIG. 1C shows the {Sn[Zn₄Sn₄S₁₇]⁶⁻} framework viewed down the c-axis.

For clearance, K3 is shown in only one of the several sub-sites which are occupied by this potassium; and FIG. 1D shows the skeletal version of the structure of {Sn[Zn₄Sn₄S₁₇]⁶⁻} which depicts the topological relationship of diamond. The yellow balls are [Zn₄Sn₄S₁₇]¹⁰⁻ clusters and red balls are linking Sn atoms (Snl).

FIG. 2 is a graph showing the PXRD patterns of K₆Sn₅Zn₄S₁₇ and of the Hg-exchanged compositions.

FIG. 3 is a graph of the representation of the % Hg removal and logK_{d} values versus the initial Hg²⁺ concentration.

FIG. 4 is a graph showing the variation with the pH of the % Hg removal.

FIG. 5 is a graph of a representation of the % Hg removal versus the reaction time.

FIG. 6 is a graph of the amount (mg) of Hg²⁺ absorbed per gram of compound (1) versus the reaction time. The line represents the fitting of the data with the Lagergren equation.

FIG. 7 is a graph of Hg²⁺ removal versus the V:m ratio.

### DESCRIPTION OF THE PREFERRED EMBODIMENTS

J. Am. Chem. Soc. 128, 8875-8883 (2006), including the present inventor, describes ion exchange (NH₄⁺ and Cs⁺) within the chalcogenide of the present invention. This reference is incorporated herein in its entirety for the preparation of the chalcogenides.

The present invention describes the unexpected very high selectivity and affinity of K₆Sn₅Zn₄S₁₇ for Hg ions over Pb and Cd ions. The affinity of K₆Sn₅Zn₄S₁₇ for Hg ions as well as the selectivity of K₆Sn₅Zn₄S₁₇ for Hg ions over Pb and Cd ions can be measured in terms of the distribution coefficient K_{d}. The higher the K_{d} value of an ion exchanger for a specific ion, the greater the affinity of the exchanger for the ion. Based on the K_{d} values, K₆Sn₅Zn₄S₁₇ is about 25 times more selective for Hg ions than for Pb ions. In addition, K_{d} values show that K₆Sn₅Zn₄S₁₇ is about 346 times more selective for Hg ions than for Cd ions. Comparing the K_{d} values of K₆Sn₅Zn₄S₁₇ for Hg with the corresponding ones for some representative examples of functionalized mesoporous silicates, K₆Sn₅Zn₄S₁₇ has an affinity for Hg²⁺ at least 2.8 times greater than that of these silicates with a high K_{d} value.

The ability of K₆Sn₅Zn₄S₁₇ to reduce the Hg content of water solutions to very low levels (<1 ppb) can be as fast as 30 min, while prior art materials tested so far need several hours to achieve low Hg concentrations in similar levels.

The organic-free synthesis of K₆Sn₅Zn₄S₁₇ uses non toxic and very cheap elements and is more cost and environmentally friendly than that of functionalized mesoporous silicates employing large quantities of organic molecules (surfactants, organic solvents and silicate forming chemicals).

The distribution coefficient K_{d} is given by the equation K_{d}=[{C₀−C_{f})/C_{f}]*V/m, where C₀ and C_{f} are the initial and equilibrium concentration of Hg²⁺ (ppm), V is the volume (ml) of the testing solution and m is the amount of the ion exchanger (g) used in the experiment.

K₆Sn₅Zn₄S₁₇ can be used for purification of waste water from industries producing electric lamps, gauges, batteries, chemicals, thermometers, paper as well as from mine water where Hg is extracted (usually as HgS). In addition, it can be used from companies producing filters for purification of the drinking water comprising the various ions of mercury.

### Example 1

Synthesis: A mixture of Sn (1.18 g), Zn (0.56 g), K₂S (1.1 g), and S (2.56 g) was sealed under vacuum (≈10⁻⁴ torr) in a 13 mm silica tube and heated (≈30° C./h) to 400° C. for 60 h, followed by cooling to room temperature at 30° C./h. The excess flux was removed with distilled water to reveal a mixture of pale yellow polyhedral-shaped crystals of K₆Sn₅Zn₄S₁₇ and orange crystals of the ternary phase K₂Sn₂S₅. Treating the mixture of K₆Sn₅Zn₄S₁₇ and K₂Sn₂S₅ with aqueous K₂C0₃ (pH≈9−10), completely dissolved the ternary phase and K₆Sn₅Zn₄S₁₇ was obtained in pure form (typical yield 1 g, 30% based on Sn), as confirmed by PXRD analysis.

### Example 2

Mercury ion exchange experiments: K₆Sn₅Zn₄S₁₇ and mercuric nitrate were mixed as solids in different ratios (1:1, 1:2, 1:2.5, 2:1, 4.5:1) and then H₂O (16 ml) was added to the mixture of the solids. Mercury nitrate was readily dissolved after H₂O addition in contrast to K₆Sn₅Zn₄S₁₇ which was insoluble in water. The resulting suspensions were stirred at 25° C. for 30 min and then, filtered through a small pore glass filter. The filtered solutions were then analyzed for Hg⁺² by ICP-AES or cold vapor atomic absorption for solutions containing Hg in concentrations less than 50 ppb.

Typical lead and cadmium ion-exchange experiments: K₆Sn₅Zn₄S₁₇ and Pb(NO₃)₂ or Cd(NO₃)₂ in a ratio of 1:1 were mixed as solids and then water (16 ml) was added to the mixture. The M(NO₃)₂ solids were readily dissolved in water, while K₆Sn₅Zn₄S₁₇ was insoluble. The suspension was stirred at ambient temperature for 30 min and then, filtered through a small pore glass filter. The Pb or Cd content of the filtered solution was determined by ICP-AES.

Typical selectivity ion-exchange experiment: K₆Sn₅Zn₄S₁₇, Pb(NO₃)₂, Hg(NO₃)₂ and Cd(NO₃)₂ were mixed as solids in a ratio 1:1:1:1 and then water (16 ml) was added to this mixture. All M(NO₃)₂ solids were readily dissolved in water, while K₆Sn₅Zn₄S₁₇ was insoluble. The suspension was stirred for half an hour and then filtered through a small pore glass filter. The filtered solution was analyzed for its Hg, Pb and Cd content by ICP-AES.

The experiments show the use of K₆Sn₅Zn₄S₁₇ for Hg remediation from water solutions containing high and moderate Hg ion concentrations. K₆Sn₅Zn₄S₁₇ showed ability to reduce the Hg content of water solutions in levels lower than those allowed by U.S. E.P.A. for drinking water. In addition, K₆Sn₅Zn₄S₁₇ was more selective for Hg than any other material tested for Hg removal so far.

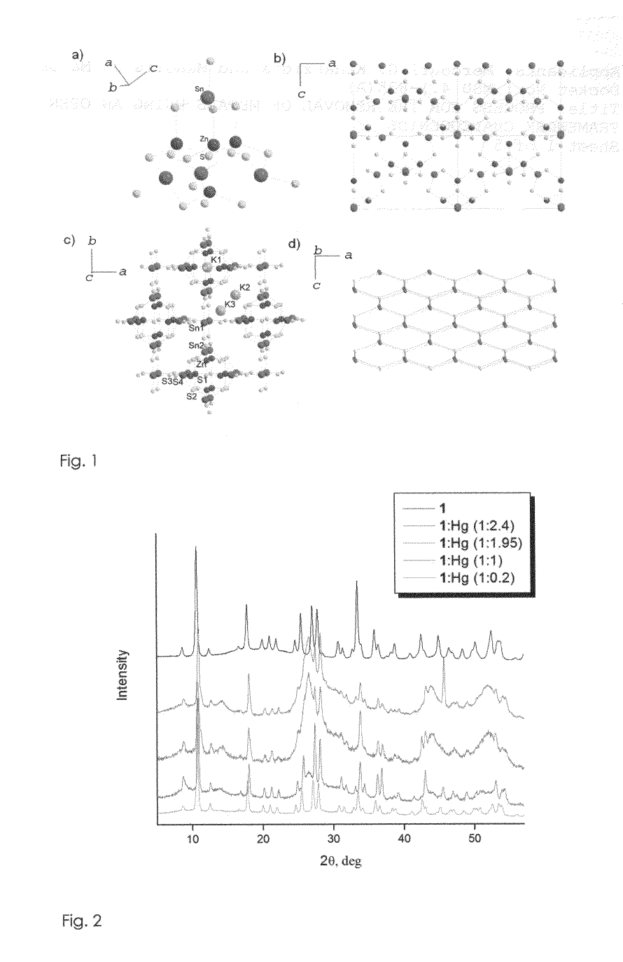

Details of the structure of K₆Sn₅Zn₄S₁₇ are shown in FIG. 1. K₆Sn₅Zn₄S₁₇ has 6 K⁺. Five of them (K2, K3) can easily be exchanged by other cations (such as Rb⁺, Cs⁺), while the unique K1 cannot be exchanged as proved by various ion-exchange experiments. Thus, 2.5 equivalents of Hg²⁺, Pb²⁺, or Cd²⁺ (which can exchange 5 K⁺) are the maximum ions that can be adsorbed by K₆Sn₅Zn₄S₁₇. Tables 1 and 2 contain data of ICP-AES analyses of solutions containing each of Hg, Pb or Cd (or all three elements) after their treatment with K₆Sn₅Zn₄S₁₇. EDS analysis data (also included in Table 1) on the solids after ion-exchange confirmed presence of Hg. Based on these analytical data, the Zn content of the solid K₆Sn₅Zn₄S₁₇ after ion-exchange seems to be reduced. In addition, the content of Hg in the solid seems to be more than the expected on based on the Hg amount used in the experiments. The low amounts of Zn (0.116-5 ppm) in the solutions analyzed with ICP exclude exchange of Hg²⁺ with Zn²⁺. The presence of Hg adsorbed in the external surface of the material can explain the modified formulae of the exchanged materials found by EDS.

An indication that the adsorption of Hg from K₆Sn₅Zn₄S₁₇ is a combination of ion-exchange and surface adsorption phenomena came from the measured (by ICP-AES) K⁺ concentration of the Hg solutions after their treatment with K₆Sn₅Zn₄S₁₇. The K⁺ concentration of these solutions is much higher (60-80 ppm) than that of the initial Hg²⁺ solution (<0.1 ppm), which indicates replacement of some K⁺ of K₆Sn₅Zn₄S₁₇ by Hg²⁺ (i.e. ion-exchange). However, the quantity of K⁺ detected in the solution is less than the calculated based on the total Hg quantity adsorbed by K₆Sn₅Zn₄S₁₇. For example, in experiments that 2.4 equivalents of Hg²⁺ were used, the quantity of K⁺ detected in the solutions treated with K₆Sn₅Zn₄S₁₇ indicates release of ≈1.8 K⁺ from K₆Sn₅Zn₄S₁₇, while 5 K⁺ of K₆Sn₅Zn₄S₁₇ should be released for adsorption of 2.5 equiv. of Hg²⁺ (if only an ion-exchange process is considered). Thus, adsorption of Hg²⁺ on surface S^{δ-} groups of K₆Sn₅Zn₄S₁₇ can also contribute to the removal of Hg²⁺ from the water solutions treated with K₆Sn₅Zn₄S₁₇. The PXRD patterns of the Hg-exchanged materials are similar with that of the pristine material, although some differences are apparent (FIG. 2). Results for removal of Hg from water solutions by using various mesoporous silicates are given for comparison with the results for K₆Sn₅Zn₄S₁₇ in Table 3.

TABLE 1
ICP-AES and cold vapor atomic absorption results
for ion-exchange experiments of K₆Sn₅Zn₄S₁₇
and Hg(NO₃)₂ in various ratios.

| | Initial | Final | mmol (Hg)/g | | |
|---|---|---|---|---|---|
| | Concen | Concen | (ion- | | EDS AFTER ION- |
| Eq. of Hg | (ppm) of Hg | (ppm) of Hg | exchanger) | K_{d} (ml/g) | EXCHANGER |
| 2.4 | 542.31 | 0.001 | 1.41 | 283560261 | Hg_{3.8}K_{1.9}Zn_{1.7}Sn_{5.8}S₁₆ |
| 1.95 | 441.50 | 0.081 | 1.15 | 2858815 | Hg_{4.8}K_{1.8}Zn_{2.2}Sn_{5.3}S_{17.4} |
| 1 | 426.25 | 0.594 | 0.60 | 205595 | Hg_{1.7}K_{2.7}Zn_{1.0}Sn_{5.4}S_{14.3} |
| 0.2 | 52.14 | 0.001 | 0.12 | 27994093 | Hg_{0.3}K_{2.2}Zn_{1.0}Sn_{6.7}S_{14.3} |

TABLE 2
ICP-AES results for ion-exchange experiments
of K₆Sn₅Zn₄S₁₇ with Pb²⁺, Cd²⁺
and mixture of Hg²⁺/Pb²⁺/Cd²⁺.

| | Initial | Initial | Initial | Final | Final | Final | | | |
|---|---|---|---|---|---|---|---|---|---|
| Eq. | Concen | Concen | Concen | Concen | Concen | Concen | | | |
| Of | (ppm) | (ppm) | (ppm) | (ppm) | (ppm) | (ppm) | | | K_{d} |
| M²⁺ | of Hg | of Pb | of Cd | of Hg | of Pb | of Cd | mmol/g | | (ml/g) |
| 1 | — | 388.50 | — | — | 0.770 | — | 0.58 | | 144386 |
| 1 | — | — | 238.87 | — | — | 15.158 | 0.57 | | 4232 |
| 1 | 689.53 | 712.25 | 386.40 | 0.224 | 5.66 | 39.1 | 0.61 | (Hg) | 550740 |
| | | | | | | | 0.61 | (Pb) | 22343 |
| | | | | | | | 0.55 | (Cd) | 1590 |

TABLE 3
Results for Hg removal using functionalized mesoporous
silicates (these silicates are some representative
examples of such materials).

| | Initial | Final | | |
|---|---|---|---|---|
| Silicate | Concen | Concen | | Ref. |
| *see below | (ppm) of Hg | (ppm) of Hg | K_{d} (ml/g) | *see below |
| FMMS | 6.2 | 0.0007 | 340141 | [2]a |
| PMPS | 3 | 0.00016 | 3812400 | [2]b |
| S12 | 10.76 | 0.23 | 4248 | [2]c |
| FMMS | 10 | 0.001 | 100000000 | [2]d |

### LIST OF ABBREVIATIONS

EDS: Energy Dispersive Spectroscopy
PXRD: Powder X-ray Diffraction
ppm: parts per million
ICP-AES: Inductively Coupled Plasma-Atomic Emission Spectroscopy
FMMS: Functionalized Monolayers on Mesoporous Supports
PMPS Polymer-captopropylsilsesquioxane
S12 1,4-bis(triethoxysilyl)-propane tetrasulfide in 12% concentration

a) X. Feng, G. E. Fryxell, L.-Q. Wang, A. Y. Kim, J. Liu, K. M. Kemner, Science 1997, 276, 923; b) C. Liu, Y. Huang, N. Naismith, J. Economy, Environ. Sci. Technol. 2003, 37, 4261; c) L. Zhang, W. Zhang, J. Shi, Z. Hua, Y. Li, J. Yan, Chem. Commun. 2003, 210. d) J. Liu, X. Feng, G. E. Fryxell, L.-Q. Wang, A. Y. Kim, M. Gong, Adv. Mater. 1998, 10, 161.

Hg²⁺ remediation properties of K₆Zn₄Sn₅S₁₇ (1).

Several factors that affect the Hg²⁺ adsorption by (1) were investigated, namely:

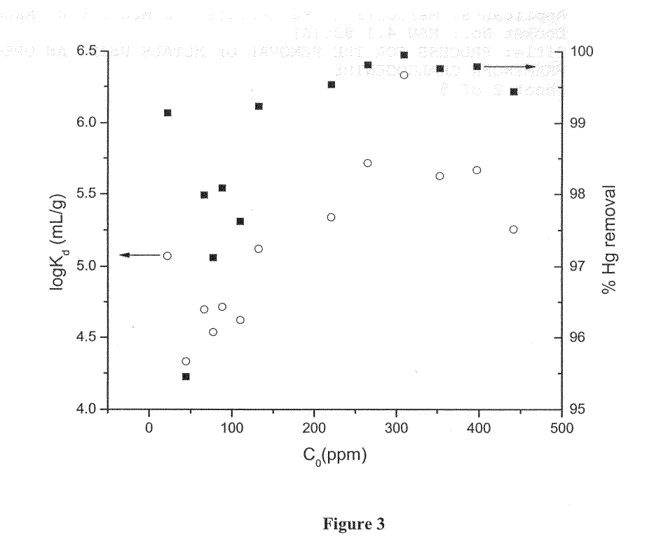

a. Initial Hg²⁺ concentration. The Hg²⁺ ion exchange was studied with the batch method (V:m=−1000:1 mL/g, pH˜5, room temperature). The initial mercury concentrations used were in the range 22-441 ppm. The results are presented in FIG. 3. It can be seen that the % Hg removal remains very high (95.45-99.95%) for the whole range of concentration tested. The variation of distribution coefficient (K_{d} with the initial concentration is also given in FIG. 3. The K_{d} values found range from 2.1×10⁴ to 2.1×10⁶ mL/g.

In addition, compound (1) seems to be efficient for Hg²⁺ adsorption even with very low mercury initial concentrations. Specifically, compound (1) can remove ˜93.9% of a Hg²⁺ solution with initial concentration of ˜114 ppb (V:m ˜500, pH ˜7, reaction time ˜19 h) lowering the mercury concentration down to ˜7 ppb.

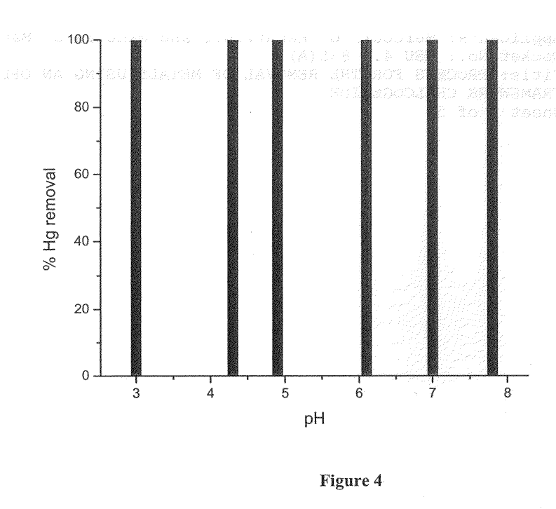

b. The pH of the solutions. The effect of pH on the Hg²⁺ ion exchange was also investigated. The pH range studied was 3-7.8. The initial Hg²⁺ concentration was ˜441 ppm and the batch factor was V:m⁻⁵⁰⁰ mL/g. The results showed that the affinity of (1) for Hg²⁺ remains exceptional (% Hg removal ≧99.96%) in the whole pH range tested (FIG. 4). It is really important that (1) displays remarkable capacity to remediate Hg²⁺ in acidic conditions, since most of oxidic adsorbents are not effective under such conditions.

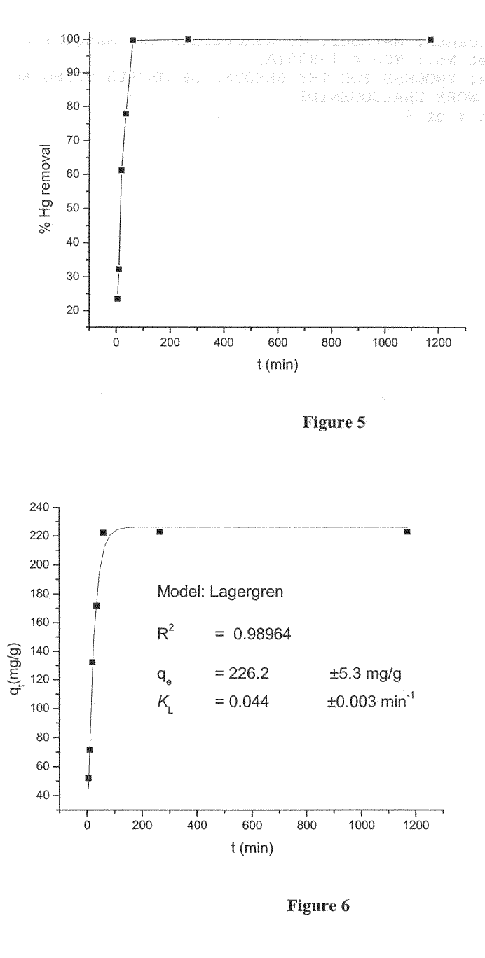

c. Kinetics of Hg²⁺ ion exchange. The Hg²⁺ exchange kinetics data, obtained at room temperature and pH˜5, for (1) are presented in FIG. 5. The initial Hg²⁺ concentration was ˜441 ppm and the batch factor was V:m˜⁵⁰⁰ mL/g. The adsorption of Hg²⁺ is remarkably fast considering that compound (1) exhibits three-dimensional structure with pores of small size. Within only 60 min, compound (1) can remove 99.64% of Hg²⁺ from the solution. The % Hg²⁺ removal (99.99%) after ˜19 h of reaction only slightly differed from that obtained within one hour of reaction. Excellent fit (R²=98.96%) of the kinetics data for the Hg²⁺ exchange (FIG. 6) can be achieved with a pseudo first-order model, namely the Lagergren first-order equation

qₜ=qₑ((1−exp(−K_{L}t))

where qₑ=the amount (mg/g) of metal ion absorbed in equilibrium, K_{L}=the Lagergren or first-rate order constant. The results of the fitting revealed a maximum Hg²⁺ adsorption capacity of 226±5 mg/g and a rate constant of 0.044±0.003 min⁻¹.

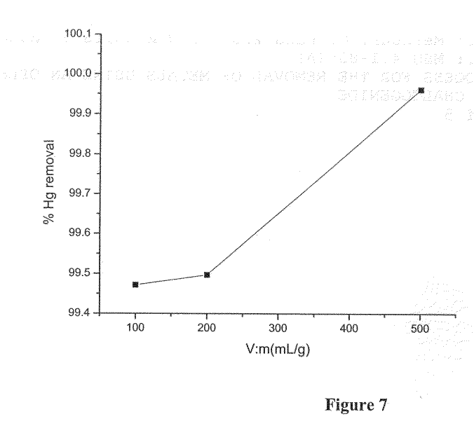

d. Effect of the batch factor (V:m). The mercury adsorption by compound (1) is strongly affected by the value of the volume of the solution (V) over the mass of the exchanger (m) ratio or batch factor. Experiments were performed with three different V:m ratios, namely 100, 200 and 500 mL/g. Specifically, 10 mL solutions with initial mercury concentration of ˜441 ppm were treated with 100, 50 and 20 mg of compound (1). The results showed that the optimum V:m ratio is 500 mL/g (FIG. 7) with 99.96% of Hg²⁺ adsorbed under such conditions. In other words, these data showed that not only is it not needed to use more than 20 mg of compound (1) to remediate 10 mL of the Hg²⁺ solution, but actually the performance of the material is better when only 20 mg of it is used, which was unexpected.

e. Effect of high electrolyte concentrations on Hg²⁺ ion exchange. Contaminated groundwater and waste stream usually contain alkali and alkali-earth cations in much higher concentrations than those of contaminants (e.g. heavy metal ions). Thus, the effect of high background electrolyte on the mercury absorption by compounds (1) was also explored. The results showed that the affinity of (1) for Hg²⁺ remains almost unaffected in the presence of Na⁺ or Ca²⁺ (Table 4). It is remarkable that even in the presence of extremely high Na⁺ or Ca²⁺ concentrations (1-5 M), the Vg values were found to be very large (1.3 to 2.0×10⁶ mL/g). This extremely high selectivity of compound (1) for Hg²⁺ over alkali and alkaline earth cations is due to two structural features uniquely combined in compound (1), namely: (i) Its small pores excluding absorption of strongly hydrated cations such as Na⁺ and Ca²⁺ and; (ii) the presence of sulfide ligands inducing to (1) high preference for soft cations such as Hg²⁺ and discrimination against hard ones such as Na⁺ and Ca²⁺. This property of compound (1) makes it superior heavy metal ion adsorbent than traditional oxidic ion exchangers showing decreased capacity for soft metal ions in the presence of high background electrolyte concentrations.

TABLE 4
Results for the competitive Hg²⁺—Na⁺ and
Hg²⁺—Ca²⁺ experiments for compound (1).

| | | | Initial | Final | | |
|---|---|---|---|---|---|---|
| | Equivalents | V:m | concentration | concentration | % | K_{d} |
| Metal ions | of metal ions | (mL/g)/pH | (ppm) | (ppm) | Removal | (mL/g) |
| Hg²⁺/Na⁺ (1 M) | 1/455 | 500/5 | 441.4 | 0.137 | 99.97 | 1.6 × 10⁶ |
| Hg²⁺/Na²⁺ (5.3 M) | 1/4818 | 1010/5 | 220.7 | 0.111 | 99.95 | 2.0 × 10⁶ |
| Hg²⁺/Ca⁺ (1 M) | 1/455 | 510/2.5 | 441.4 | 0.170 | 99.96 | 1.3 × 10⁶ |

g. Competition by Pb²⁺ and Cd²⁺ on Hg²⁺ exchange. In contaminated waste water, the presence of a variety of soft heavy metal ions is possible. Therefore, the effect of the soft ions Pb²⁺ and Cd²⁺ on the Hg²⁺ exchange was also investigated. We found that the preference of the material for Hg²⁺ over Pb²⁺ and Cd²⁺ strongly depends on the initial concentrations of these ions (Table 5). Experiments with large initial concentrations revealed that the selectivity of compound (1) follows the order Hg²⁺>Pb²⁺>Cd²⁺. However, the results of experiments with lower initial concentrations of the metal ions (˜166, 67.6 and 39.7 ppm for Hg²⁺, Pb²⁺ and Cd²⁺ respectively) were different. Specifically, they showed that the material is more selective for Pb²⁺ and shows similar selectivity for Hg²⁺ and Cd²⁺ (although Hg²⁺ was in 2.6-fold excess with respect to Pb²⁺ and Cd²⁺). It is interesting that the data for experiments with even lower initial concentrations (˜16.62, 6.76 and 3.97 ppm for Hg²⁺, Pb²⁺ and Cd²⁺ respectively) revealed the selectivity order Cd²⁺>Hg²⁺>Pb²⁺. In general, all competitive Hg₂₊—Pb²⁺—Cd² experiments showed that compound (1) displays high efficiency for adsorption of Pb²⁺ and Cd²⁺ (besides Hg²⁺) and may be used for remediation of waste water contaminated with various soft heavy metal ions.

TABLE 5
Results for the competitive Hg²⁺—Pb²⁺—Cd² experiments for compound (1).

| | | | Initial | | Final | | | | | |
|---|---|---|---|---|---|---|---|---|---|---|
| | Equivalents | V:m | concentration | | concentration | | % | | | |
| Metal ions | of metal ions | (mL/g) | (ppm) | | (ppm) | | Removal | | K_{d}(mL/g) | |
| Hg²⁺/Pb²⁺/Cd²⁺ | 1/1/1 | 179 | 689.5 | (Hg) | 0.224 | (Hg) | 99.96 | (Hg) | 5.50 × 10⁵ | (Hg) |
| | | | 712.3 | (Pb) | 5.66 | (Pb) | 99.20 | (Pb) | 2.20 × 10⁴ | (Pb) |
| | | | 386.4 | (Cd) | 39.1 | (Cd) | 89.88 | (Cd) | 1.59 × 10³ | (Cd) |
| Hg²⁺/Pb²⁺/Cd²⁺ | 2.6/1/1 | 485 | 166.25 | (Hg) | 2.127 | (Hg) | 98.72 | (Hg) | 3.70 × 10⁴ | (Hg) |
| | | | 67.625 | (Pb) | 0.174 | (Pb) | 99.74 | (Pb) | 1.88 × 10⁵ | (Pb) |
| | | | 39.575 | (Cd) | 0.455 | (Cd) | 98.85 | (Cd) | 4.17 × 10⁴ | (Cd) |
| Hg²⁺/Pb²⁺/Cd²⁺ | 2.6/1/1 | 505 | 16.625 | (Hg) | 2.083 | (Hg) | 87.47 | (Hg) | 3.53 × 10³ | (Hg) |
| | | | 6.762 | (Pb) | 1.99 | (Pb) | 70.57 | (Pb) | 1.20 × 10³ | (Pb) |
| | | | 3.957 | (Cd) | 0.191 | (Cd) | 95.17 | (Cd) | 9.96 × 10³ | (Cd) |

Adsorption of other metal ions by K₆Zn₄Sn₅ S₁₇ (1). A variety of other harmful metal ions can be absorbed by compound (1) including Ag⁺, Tl⁺, Cu²⁺ and UO₂²⁺. Some results for Ag⁺ and Tl⁺ ion exchange of (1) are presented in Tables 3 and 4 respectively. It can be seen that the material is very effective for removal of these cations from water solutions showing % Ag⁺ and Tl⁺ removal capacities as high as 99.99 and 99.70 respectively.

TABLE 6
Results for Ag⁺ exchange experiments for compound (1).

| | Initial | Final | | |
|---|---|---|---|---|
| Ag⁺/(1) | concentration | concentration | % | |
| molar ratio | (ppm) of Ag | (ppm) of Ag | Removal | K_{d}(mL/g) |
| 2.18 | 250 | 0.013 | 99.99 | 1.10 × 10⁷ |
| 4.05 | 464 | 0.083 | 99.98 | 3.17 × 10⁶ |

TABLE 7
Results for Tl⁺ exchange experiments for compound (1).

| Tl⁺/(1) | Initia Tl | Final Tl | Tl (%) | |
|---|---|---|---|---|
| molar ratio | (ppm) | (ppm) | adsorbed | K_{d}(mL/g) |
| 1 | 157.2 | 0.735 | 99.5 | 2.18 × 10⁵ |
| 2 | 268.54 | 1.06 | 99.6 | 2.61 × 10⁵ |
| 3 | 383.61 | 1.12 | 99.7 | 3.42 × 10⁵ |
| 4 | 506.37 | 6.040 | 98.8 | 8.28 × 10⁴ |
| 5 | 632.95 | 119 | 81.2 | 4.32 × 10³ |

Experimental Details

Kinetic studies. Hg²⁺ ion-exchange experiments of various reaction times were performed. For each experiment, a total of 10 mg of compound (1) was weighted into a 20 ml glass vial. A 5 mL sample of a Hg²⁺ [˜441 ppm] solution was added to each vial and the mixtures were shaken on a orbital shaker for the designated reaction times. The suspensions from the various reactions were centrifuged and the supernatant solutions were analyzed for their mercury content by Inductively Coupled Plasma-Mass Spectroscopy (ICP-MS).

Inductively Coupled Plasma-Mass Spectroscopy [ICP-MS] analyses. Accurate determination of Hg²⁺, Pb²⁺ and Cd²⁺ in solutions after ion-exchange was performed by ICP-MS. Quadrupole ICP-MS is capable of identifying elements from ppt-ppb levels. To accurately determine the amount of Hg²⁺, Pb²⁺ and Cd²⁺, a computer-controlled Thermo Elemental (Waltham, Mass.) PQ ExCell Inductively Coupled Plasma Mass Spectrometer (ICP-MS) with a quadrupole setup was used. Isotopes ¹⁹⁹Hg, ²⁰⁰Hg, ²⁰²Hg, ²⁰⁶Pb, ²⁰⁷Pb, ¹¹¹Cd, ¹¹²Cd and ¹¹⁴Cd were analyzed. Ten standards of Hg²⁺Pb²⁺ and Cd² in the range of 1-40 ppb were prepared by diluting commercial (Aldrich or GFS chemicals) 1000 ppm solutions. All samples (including standards) were prepared in a 3% aqua regia (HCl:HNO₃=3:1 v/v) solution with 1 ppb ¹¹⁵In internal standard in order to correct for instrumental drift and matrix effects during analysis. To help stabilization of Hg²⁺ in solution and to avoid contamination of the plasma by trace mercury amounts, solution of Au (of ˜10 times higher in concentration than Hg) was added to the standards and the Hg-containing samples.

It is intended that the foregoing description be only illustrative of the present invention and that the present invention be limited only by the hereinafter appended claims.

We claim:

1. A process for the separation of heavy or soft metal ions in ionic form from a fluid which comprises:
(a) providing a chalogenide, having the formula A₆Sn₅Zn₄S₁₇ where A is an alkali metal ion and an open framework comprised of the A ion group in the pores of the framework, in a fluid comprising the metal ions, so that the metal ions displace at least some of the A ions in the framework openings to provide a metal chalogenide; and
(b) separating the metal chalogenide from the fluid.

2. A process for the separation of heavy metal ions in ionic form from a fluid which comprises:
(a) providing a chalogenide, having the formula A₆Sn₅Zn₄S₁₇ where A is an alkali metal ion and an open framework comprised of the A ion group in the pores of the framework, in a fluid comprising the heavy metal ions, so that the heavy metal ions displace at least some of the A ions in the framework openings to provide a heavy metal chalogenide; and
(b) separating the heavy metal chalogenide from the fluid.

3. A process for the separation of mercury ions in ionic form from a liquid which comprises:
(a) providing a chalogenide, having the formula K₆Sn₅Zn₄S₁₇ and having an open framework comprised of potassium ions in openings in the framework, in the liquid comprising the mercury in ionic form so that the mercury displaces at least some of the potassium ions in the framework openings to provide a mercuric chalcogenide; and
(b) separating the mercuric chalcogenide from the liquid.

4. A process for the separation of mercury in an ionic form from an aqueous solution which comprises:
(a) introducing a chalcogenide having the formula K₆Sn₅Zn₄S₁₇ and an open framework comprised of potassium ions in openings in an aqueous solution comprising the mercury in the ionic form so that the mercury displaces at least some of the potassium ions in the framework openings to provide a mercuric chalcogenide; and
(b) separating the mercuric chalcogenide from the aqueous solution.

5. The process of claims 1 or 2 wherein sodium or calcium ions are produced in an aqueous solution with the mercury ions.

6. The process of claim 1 wherein the metal is selected from the group consisting of: Ag⁺, Cd²⁺, CH³Hg⁺, Pb²⁺, Tl⁺, Au⁺ and Pd²⁺, and mixtures thereof.

7. A heavy metal chalcogenide of the formula MₓK_{y}Sn₅Zn₄S₁₇ where M is the heavy metal, x is between 0.5 and 2.5, y is 5−2x.

8. A mercury chalcogenide having the formula HgₓK₅₋₂ₓ, Sn₅Zn₄S₁₇ with an open framework comprised of mercury and potassium ions in openings of the framework and where x is between 0.5 and 2.5, y is 5−2x.

9. The chalcogenide of claim 7 wherein the heavy metal is selected from the group consisting of Au, Ag, Pb, Cu and mixtures thereof.

10. A process for the separation of soft or heavy metal ions in ionic form from a fluid which comprises providing a chalogenide, having the formula A₆Sn₅Z₄S₁₇ where A is an alkali metal ion and an open framework comprised of the A ion group in the pores of the framework, and where Z is selected from the group consisting of Zn, Mn, and Mg or mixtures thereof, in a fluid comprising the metal ions, so that the metal ions displace at least some of the A ions in the framework openings to provide a metal chalcogenide to separate the metal ions from the fluid.
